(19) United States
(12) Patent Application Publication
(10) Pub. No.: US 2024/0386373 A1
(43) Pub. Date: Nov. 21, 2024

(54) METHODS AND SYSTEMS FOR MACHINE LEARNING TO PROVIDE FORECASTING FOR MATERIAL REQUIREMENTS PLANNING AND INVENTORY CONTROLS

(71) Applicant: Epicor Software Corporation, Austin, TX (US)

(72) Inventors: Arturo P. Buzzalino, Madison, AL (US); Vaibhav Vohra, San Ramon, CA (US); Aieat Assam, Halesowen (GB)

(21) Appl. No.: 18/662,452

(22) Filed: May 13, 2024

Related U.S. Application Data
(60) Provisional application No. 63/502,282, filed on May 15, 2023.

(51) Int. Cl. G06Q 10/087

(52) U.S. Cl. CPC G06Q 10/087

(57) ABSTRACT

Embodiments are directed to providing real-time forecasting for material requirements planning and inventory controls based on data from a variety of sources. More specifically, embodiments are directed to collecting data from sources including, but not limited to, manufacturing, inventory, and supplier data sources, and focusing on the most important data signals in near real-time, focusing on critical suppliers and inventory, and creating critical alerts while also enabling predictive analytics and machine learning to automate the processes and providing an ability to manage all the data.

### CROSS REFERENCE TO RELATED APPLICATION

The present application claims the benefits of and priority, under 35 U.S.C. § 119 (e), to U.S. Provisional Application No. 63/502,282 filed May 15, 2023 by Buzzalino et. al. and entitled “Methods and Systems for Machine Learning to Provide Forecasting for Material Requirements Planning and Inventory Controls” of which the entire disclosure is incorporated herein by reference for all purposes.

### FIELD OF THE DISCLOSURE

Embodiments of the present disclosure relate generally to methods and systems for real-time processing of data from a variety of sources and more particularly to providing real-time forecasting for material requirements planning and inventory controls based on data from a variety of sources.

### BACKGROUND

As known in the art, an Enterprise Resource Planning (ERP) system can provide integrated management of main business processes, often in real time and mediated by software and technology. ERP is usually referred to as a category of business management software, typically a suite of integrated applications, that an organization can use to collect, store, manage and interpret data from many business activities. ERP systems can be local based or cloud-based.

ERP provides an integrated and continuously updated view of core business processes using common databases maintained by a database management system. ERP systems track business resources such as cash, raw materials, production capacity and the status of business commitments, e.g., orders, purchase orders, and payroll. The applications that make up the system share data across various departments (manufacturing, purchasing, sales, accounting, etc.) that provide the data. ERP facilitates information flow between all business functions and manages connections to outside stakeholders.

Today, ERP systems can provide complex, made-to-order discrete manufacturing along with repetitive and process-based manufacturing. These system help ensure that resources are aligned with capacity for defined business constraints. The definition of these constraints is relatively simple for discrete processes like the number of machines, the number of people, etc., but becomes much more difficult when they are random in nature (stochastic), such as: demand, inventory, lead time, etc. Historically, one of the challenges of complex made-to-order manufacturing has been to elevate the role of predictive analytics and automation to not only fuel demand forecasting to improve Material Requirements Planning (MRP), but also create powerful signals to drive complex decisions for the ‘factory of the future’. Taking real-time signals from a number of key variables, e.g., from suppliers, the plant itself, IoT devices, etc., can enable both plant managers and plant leaders to unlock the power of back office and operational ERP to better manage disruptions and day to day operations. Hence, there is a need for improved methods and systems for real-time processing to provide forecasting for material requirements planning and inventory controls.

### BRIEF SUMMARY

Embodiments of the present disclosure are directed to focusing on the most important data signals in near real-time, focusing on critical suppliers and inventory, and creating critical alerts while also enabling predictive analytics and machine learning to automate the processes and providing an ability to manage all the data. According to one embodiment, a method for forecasting material requirements planning and inventory controls in an Enterprise Resource Planning (ERP) system can comprise collecting data from one or more data sources. The one or more data sources can comprise manufacturing data sources, inventory data sources, and/or supplier data sources. One or more artificial intelligence processes can be to collect the data based on one or more trained models. The one or more trained models can comprise one or more demand models, one or more inventory level optimization models, and/or one or more supply chain flow models. One or more insights to the data can be generated from the one or more artificial intelligence processes. The generated insights can comprise one or more of real-time forecasts of demand, changes in the supply chain, detected or predicted disruptions, and/or detected or predicted changes in price for goods and/or services, etc. One or more actions can be generated from the generated insights. The generated actions can comprise one or more of reports, notifications, alerts, and/or automatic actions initiated by the ERP system based on the generated insights.

For example, applying the one or more artificial intelligence processes to the collected data can comprise initiating an electronic communication within the ERP system, extracting one or more records from the maintained data, and sending the extracted one or more records and an indication of a requested communication type to an artificial intelligence system. The artificial intelligence system can receive the extracted one or more records and the indication of the requested communication type from the ERP system, generate the electronic communication based on the requested communication type, the received one or more records, the one or more trained models, and a large language model, and return the generated electronic communication to the ERP system. The ERP system can receive the generated electronic communication from the artificial intelligence system, present the received generated electronic communication for approval, and in response to receiving an approval of the generated electronic communication, send the generated electronic communication to a recipient.

In another example, applying the one or more artificial intelligence processes to the collected data can comprise receiving an electronic communication and forwarding the received electronic communication to the artificial intelligence system. The artificial intelligence system can receive the electronic communication forwarded by the processor of the ERP system, analyze the received electronic communication based on the one or more trained models and a large language model, generate the one or more records based on the analyzing of the received electronic communication, and return the generated one or more records to the ERP system. The ERP system can receive the one or more generated records of data from the artificial intelligence system, store the received one or more records of data, present the received one or more records for approval, and in response to receiving an approval of the presented on or more records, convert the received one or more records to one or more suggested actions and send the one or more suggested actions to one or more recipients.

According to another embodiment, a system can comprise a communications network and an ERP system coupled with the communications network. The ERP system comprising a processor and a memory coupled with and readable by the processor and storing therein a set of instructions which, when executed by the processor, causes the processor to collect data from one or more data sources, apply one or more artificial intelligence processes to the collected data and based on one or more trained models, generate, from the one or more artificial intelligence processes, one or more insights to the data, and generate one or more actions from the generated insights. The one or more trained models can comprise one or more demand models, one or more inventory level optimization models, and/or one or more supply chain flow models. The one or more data sources can comprise manufacturing data sources, inventory data sources, and/or supplier data sources. The generated insights can comprise one or more of real-time forecasts of demand, changes in the supply chain, detected or predicted disruptions, and/or detected or predicted changes in price for goods and/or services, etc. The generated actions can comprise one or more of reports, notifications, alerts, and/or automatic actions initiated by the ERP system based on the generated insights.

In some cases, applying the one or more artificial intelligence processes to the collected data can comprise initiating an electronic communication within the ERP system, extracting one or more records from the maintained data, sending the extracted one or more records and an indication of a requested communication type to an artificial intelligence system via the communication network, and receiving a generated electronic communication from the artificial intelligence system via the communication network. Applying the one or more artificial intelligence processes to the collected data can further comprise presenting the received generated electronic communication for approval and in response to receiving an approval of the generated electronic communication, sending the generated electronic communication to a recipient via the communication network.

Additionally, or alternatively, applying the one or more artificial intelligence processes to the collected data can comprise receiving an electronic communication via the communication network, forwarding the received electronic communication to the artificial intelligence system via the network, receiving one or more generated records of data from the artificial intelligence system via the communication network, and storing, by the processor of the ERP system, the received one or more records of data. Applying the one or more artificial intelligence processes to the collected data can further comprise presenting the received one or more records for approval and in response to receiving an approval of the presented one or more records, converting the received one or more records to one or more suggested actions and sending the one or more suggested actions to one or more recipients via the communication network.

### BRIEF DESCRIPTION OF THE DRAWINGS

FIG. 1 is a block diagram illustrating elements of an exemplary computing environment in which embodiments of the present disclosure may be implemented.

FIG. 2 is a block diagram illustrating elements of an exemplary computing device in which embodiments of the present disclosure may be implemented.

FIG. 3 is a block diagram illustrating an exemplary environment in which machine learning and artificial intelligence can be applied to provide forecasting for material requirements planning and inventory controls according to one embodiment of the present disclosure.

FIG. 4 is a flowchart illustrating an exemplary process for applying machine learning and artificial intelligence to provide forecasting for material requirements planning and inventory controls according to one embodiment of the present disclosure.

FIG. 5 is a flowchart illustrating additional details of an exemplary process for generating insights and actions according to one embodiment of the present disclosure.

FIG. 6 is a flowchart illustrating additional details of an exemplary process for generating insights and actions according to another embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

In the following description, for the purposes of explanation, numerous specific details are set forth in order to provide a thorough understanding of various embodiments disclosed herein. It will be apparent, however, to one skilled in the art that various embodiments of the present disclosure may be practiced without some of these specific details. The ensuing description provides exemplary embodiments only and is not intended to limit the scope or applicability of the disclosure. Furthermore, to avoid unnecessarily obscuring the present disclosure, the ensuing description omits a number of known structures and devices. This omission is not to be construed as a limitation of the scopes of the claims. Rather, the ensuing description of the exemplary embodiments will provide those skilled in the art with an enabling description for implementing an exemplary embodiment. It should, however, be appreciated that the present disclosure may be practiced in a variety of ways beyond the specific detail set forth herein.

While the exemplary aspects, embodiments, and/or configurations illustrated herein show the various components of the system collocated, certain components of the system can be located remotely, at distant portions of a distributed network, such as a Local-Area Network (LAN) and/or Wide-Area Network (WAN) such as the Internet, or within a dedicated system. Thus, it should be appreciated that the components of the system can be combined in to one or more devices or collocated on a particular node of a distributed network, such as an analog and/or digital telecommunications network, a packet-switch network, or a circuit-switched network. It will be appreciated from the following description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire or fiber optics, and may take the form of acoustic or light waves, such as those generated during radio-wave and infra-red data communications.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, Non-Volatile Random-Access Memory (NVRAM), or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a Compact Disk Read-Only Memory (CD-ROM), any other optical medium, punch cards, paper tape, any other physical medium with patterns of holes, a Random-Access Memory (RAM), a Programmable Read-Only Memory (PROM), and Erasable Programmable Read-Only Memory (EPROM), a Flash-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, Radio Frequency (RF), etc., or any suitable combination of the foregoing.

The terms “determine,” “calculate,” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

In yet another embodiment, the systems and methods of this disclosure can be implemented in conjunction with a special purpose computer, a programmed microprocessor or microcontroller and peripheral integrated circuit element(s), an Application Specific Integrated Circuit (ASIC) or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL), special purpose computer, any comparable means, or the like. In general, any device(s) or means capable of implementing the methodology illustrated herein can be used to implement the various aspects of this disclosure. Exemplary hardware that can be used for the disclosed embodiments, configurations, and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or Very Large-Scale Integration (VLSI) design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or Common Gateway Interface (CGI) script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

Various additional details of embodiments of the present disclosure will be described below with reference to the figures. While the flowcharts will be discussed and illustrated in relation to a particular sequence of events, it should be appreciated that changes, additions, and omissions to this sequence can occur without materially affecting the operation of the disclosed embodiments, configuration, and aspects.

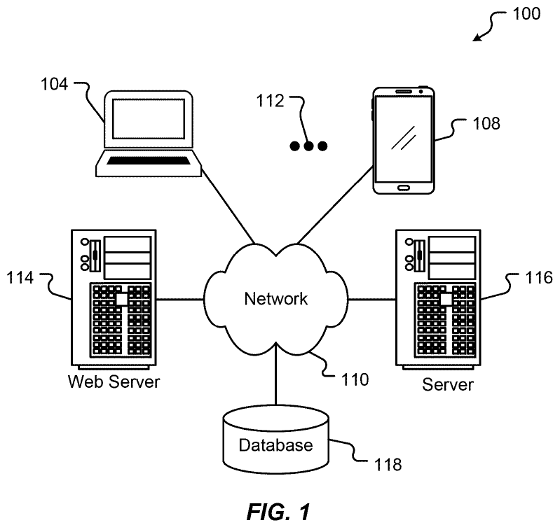

FIG. 1 is a block diagram illustrating elements of an exemplary computing environment in which embodiments of the present disclosure may be implemented. More specifically, this example illustrates a computing environment 100 that may function as the servers, user computers, or other systems provided and described herein. The environment 100 includes one or more user computers, or computing devices, such as a computing device 104, a communication device 108, and/or more 112. The computing devices 104, 108, 112 may include general purpose personal computers (including, merely by way of example, personal computers, and/or laptop computers running various versions of Microsoft Corp.'s Windows® and/or Apple Corp.'s Macintosh® operating systems) and/or workstation computers running any of a variety of commercially-available UNIX® or UNIX-like operating systems. These computing devices 104, 108, 112 may also have any of a variety of applications, including for example, database client and/or server applications, and web browser applications. Alternatively, the computing devices 104, 108, 112 may be any other electronic device, such as a thin-client computer, Internet-enabled mobile telephone, and/or personal digital assistant, capable of communicating via a network 110 and/or displaying and navigating web pages or other types of electronic documents. Although the exemplary computer environment 100 is shown with two computing devices, any number of user computers or computing devices may be supported.

Environment 100 further includes a network 110. The network 110 may be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 may be a LAN, such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The system may also include one or more servers 114, 116. In this example, server 114 is shown as a web server and server 116 is shown as an application server. The web server 114 may be used to process requests for web pages or other electronic documents from computing devices 104, 108, 112. The web server 114 can be running an operating system including any of those discussed above, as well as any commercially-available server operating systems. The web server 114 can also run a variety of server applications, including SIP servers, HyperText Transfer Protocol (secure) (HTTP(s)) servers, FTP servers, CGI servers, database servers, Java servers, and the like. In some instances, the web server 114 may publish operations or available operations as one or more web services.

The environment 100 may also include one or more file and or/application servers 116, which can, in addition to an operating system, include one or more applications accessible by a client running on one or more of the computing devices 104, 108, 112. The server(s) 116 and/or 114 may be one or more general purpose computers capable of executing programs or scripts in response to the computing devices 104, 108, 112. As one example, the server 116, 114 may execute one or more web applications. The web application may be implemented as one or more scripts or programs written in any programming language, such as Java™, C, C#®, or C++, and/or any scripting language, such as Perl, Python, or Tool Command Language (TCL), as well as combinations of any programming/scripting languages. The application server(s) 116 may also include database servers, including without limitation those commercially available from Oracle®, Microsoft®, Sybase®, IBM® and the like, which can process requests from database clients running on a computing device 104, 108, 112.

The web pages created by the server 114 and/or 116 may be forwarded to a computing device 104, 108, 112 via a web (file) server 114, 116. Similarly, the web server 114 may be able to receive web page requests, web services invocations, and/or input data from a computing device 104, 108, 112 (e.g., a user computer, etc.) and can forward the web page requests and/or input data to the web (application) server 116. In further embodiments, the server 116 may function as a file server. Although for ease of description, FIG. 1 illustrates a separate web server 114 and file/application server 116, those skilled in the art will recognize that the functions described with respect to servers 114, 116 may be performed by a single server and/or a plurality of specialized servers, depending on implementation-specific needs and parameters. The computer systems 104, 108, 112, web (file) server 114 and/or web (application) server 116 may function as the system, devices, or components described herein.

The environment 100 may also include a database 118. The database 118 may reside in a variety of locations. By way of example, database 118 may reside on a storage medium local to (and/or resident in) one or more of the computers 104, 108, 112, 114, 116. Alternatively, it may be remote from any or all of the computers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers 104, 108, 112, 114, 116 may be stored locally on the respective computer and/or remotely, as appropriate. The database 118 may be a relational database, such as Oracle 20i®, that is adapted to store, update, and retrieve data in response to Structured Query Language (SQL) formatted commands.

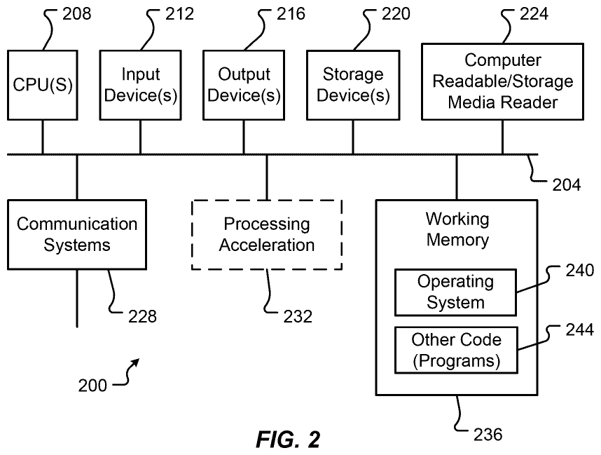

FIG. 2 is a block diagram illustrating elements of an exemplary computing device in which embodiments of the present disclosure may be implemented. More specifically, this example illustrates one embodiment of a computer system 200 upon which the servers, user computers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any one or more of the servers and/or other computing devices described above can be adapted to provide an Enterprise Resource Planning (ERP) system. Generally speaking, embodiments of the present disclosure are directed to collecting data from sources including, but not limited to, manufacturing, inventory, and supplier data sources, and focusing on the most important data signals in near real-time, focusing on critical suppliers and inventory, and creating critical alerts while also enabling predictive analytics and machine learning to automate the processes and providing an ability to manage all the data.

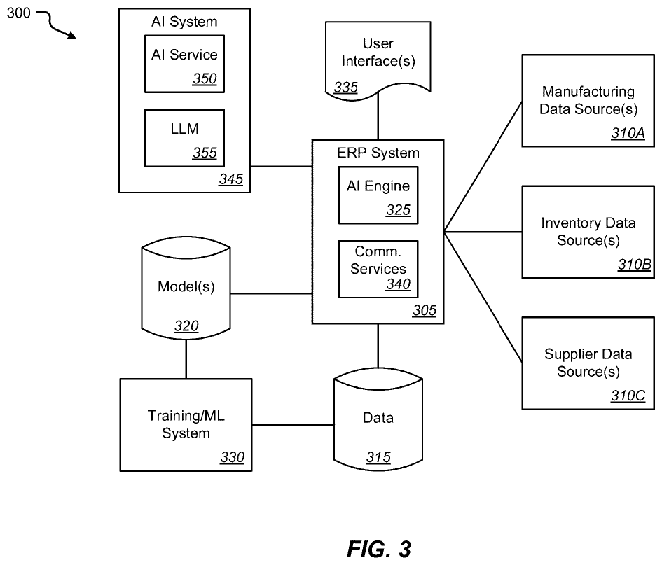

FIG. 3 is a block diagram illustrating an exemplary environment in which machine learning and artificial intelligence can be applied to provide forecasting for material requirements planning and inventory controls according to one embodiment of the present disclosure. As illustrated in this example, the environment 300 can comprise an ERP system 305 coupled with a variety of data sources 310A-310C via a communication network (not shown here). The ERP system 305 can comprise any one or more servers and/or other computing devices as described above. The communication network can comprise any of a variety of wired and/or wireless, local-area and/or wide-area networks as described above.

The data sources 310A-310C can include, but are not limited to, manufacturing data sources 310A such as those collected by various sensors, systems, and devices, throughout a manufacturing facility. According to one embodiment, these sources can include Internet-of-Things (IoT) devices on equipment, parts, etc. The data sources can additionally, or alternatively, include inventory data sources 310B from one of more warehouses, distribution centers, etc. and various systems and/or sensors therein as known in the art, supplier data sources 310C from various systems of merchants and/or other suppliers of goods and/or services as known in the art, as well as others including, but not limited to newsfeeds, weather forecasts, economic indicators, etc. The data collected from these sources 310A-31C can be stored by the ERP system 305 in any number of databases or other repositories 315 accessible by the ERP system 305.

Embodiments of the present disclosure are directed to improvements to the ERP system's ability to utilize the collected data, in real time, to provide insights on that data and generate actions based on those insights. Accordingly, the environment 300 can also comprise a set of models 320 utilized by an Artificial Intelligence (AI) engine 325 of the ERP system 305 to analyze the data collected by the ERP system 305. These models 320 can include, but are not limited to, models defining demand, inventory level optimization, supply chain flows, etc. These models can be trained, initially and or on an ongoing basis, by a training/machine learning system 330 based on the collected data and results of forecasts, insights, and/or actions generated by the AI engine 325. Once forecasts and/or actions are generated, they can be presented in various forms. In some cases, they may be presented as reports through a user interface 335. In other cases, the actions can comprise notifications or alerts to various human and/or machine entities. In some cases, the notifications and/or alerts provided, the details in each, etc. can be tailored to a role or level of the entity receiving the notification of alert, e.g., a C-level executive vs. a production manager. According to one embodiment, the notifications and/or alerts, reports presented through the user interface 335, and other communication can be generated using natural language processing techniques as will be described further below.

For example, the AI engine 325 of the ERP system 305 can leverage advanced data analytics and forecasting algorithms to provide insights into demand patterns, enabling manufacturers to optimize their production schedules, allocate resources more efficiently, and manage inventory levels effectively. The ERP system 305 can analyze historical data and market trends to forecast future demand and help manufacturers anticipate customer requirements more accurately.

Additionally, or alternatively, the inventory optimization features of the ERP system 305 can help manufacturers optimize their inventory levels by providing real-time data on inventory levels, demand, and supply. This data can be used to develop algorithms that analyze inventory levels and demand patterns to recommend optimal inventory levels for each product based on ever changing lead-times. This can help manufacturers avoid overstocking or understocking, minimize inventory holding costs, and reduce the risk of stockouts.

Predictive maintenance features can additionally, or alternatively, help manufacturers identify potential equipment failures before they occur, allowing for preventive maintenance to be performed. This can reduce downtime and maintenance costs, improve equipment reliability and efficiency, and increase the lifespan of equipment. This can be applied to not just equipment but also vendor lead times and suggestions.

Additionally, or alternatively, the ERP system 305 can provide an IoT integration feature that can generate enormous amounts of actionable data. This data can be used to optimize production schedules, reduce downtime, improve quality, and increase efficiency. The system can also provide alerts and notifications in case of equipment failure or supply chain disruptions, enabling manufacturers to respond proactively.

In some cases, the ERP system 305 can provide Environmental, Social, and Governance (ESG) reporting capabilities to help manufacturers track their sustainability performance and meet regulatory and customer demands for sustainable products. The ERP system 305 can track environmental impact, social responsibility, and corporate governance factors, enabling manufacturers to make data-driven decisions that align with their sustainability goals. This can help manufacturers increase their brand value, reduce risks, and meet the expectations of customers, investors, and regulators.

According to one embodiment, actions initiated and/or performed by the ERP system 305 based on the analysis described above can comprise responding to and/or generating an electronic communication such as an email, for example. Accordingly, the ERP system 305 can further comprise a communication service 340. Generally speaking, and as will be described in greater detail below, the communication service 340 can utilize an AI system 345 to generate and/or respond to electronic communications. The AI system 345 can provide an AI service 350 through which the communication service 340 of the ERP system 305 can access and utilize a Large Language Model (LLM) of the AI system 345. It should be noted that, while illustrated here as separate from the ERP system 305, the AI system 345 can be implemented as part of or separate from the ERP system 305. For example, and in one implementation, the AI system 345 may be implemented on one or more third-party servers and/or other computing devices and the AI service 350 may be accessible to the ERP system 305 via a communications network (not shown here) such as the Internet. In other cases, the AI system 345 may be implemented in whole or in part on systems also providing the ERP system 305.

Generally speaking, and regardless of the exact implementation, the communication services 340 of the ERP system 305 can utilize the large language model 355 of the AI system 345 to both write outgoing communications, e.g., emails, as well as analyze responses to provide a visual interface on the status of various processes such as PO suggestions and resultant RFQs and supplier responses. The capability of the AI system 345 to parse unstructured text in the form of email communication or other messaging system output into structured data understandable by the ERP system 305 and vice versa can be leveraged in other additional areas, including but not limited to aforementioned supplier RFQs, purchase order acknowledgements, internal approvals, and others.

According to one embodiment, when preparing a new communication, e.g., an email requesting an RFQ, rather than writing an email manually, an end user of the ERP system 305 can press a button in the user interface 335 or otherwise request creation of the communication. In other example, the process can be triggered automatically based on the occurrence of a set of predefined conditions and/or events. In response, the communication services module 340 of the ERP system 305 can extract relevant records saved in the repository 315 along with child fields for the records, e.g. RFQ entry in the ERP system 305 with associated supplier RFQ choices pending submission, and send the record as text payload together with communication type required, e.g. RFQ request, to the AI service 350. In response, the AI system 345 can generate a well-formed email body and subject with HTML-formatted tables to reflect the record desired and return it to the ERP system 305. The ERP system 305 can store the email body to permit review prior to sending it out. Users of the ERP system 305 can then pull up and review generated emails, e.g., through a dashboard presented in a user interface 335, and then authorize the email to be sent out.

Additionally, or alternatively, when a new email is delivered to a SAT mailbox, relevant emails can be forwarded to the AI service 350, e.g., through a mailbox associated with the AI service 350. From here, the AI system 345 can pull the email and process it based on preconfigured rules. This processing can include analyzing the email text and interpreting intent of the email and then, based on the intent, analyzing the email and its attachments to generate structured records of the required type, e.g., an RFQ response. Once these records are returned to the ERP system 305, they can be presented for review, e.g., in a dashboard of a user interface 335 alongside the email for review. In some cases, a best RFQ response identified based on selected criteria, e.g., such as optimal need by date, can be highlighted in the dashboard. Users of the ERP system 305 can then authorize the emails to be applied to the ERP system 305, e.g., resulting in RFQ responses being automatically loaded into the ERP system 305. For example, a user can select an RFQ response, including ones not suggested as such by the AI system 345, and mark these as the ones to progress. The selected RFQ response can then be converted to PO suggestion and sent to purchasing department for action.

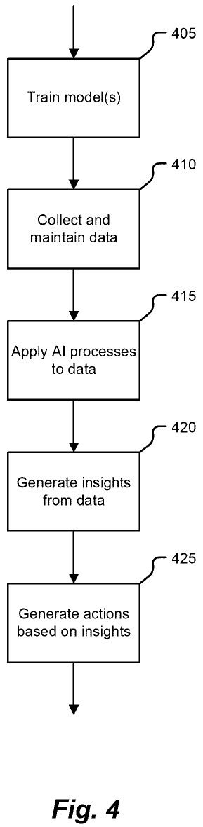

FIG. 4 is a flowchart illustrating an exemplary process for applying machine learning and artificial intelligence to provide forecasting for material requirements planning and inventory controls according to one embodiment of the present disclosure. As illustrated in this example, the process can begin with training 405 one or more models 320. As noted above, these models 320 can include, but are not limited to, one or more demand models, inventory level optimization models, supply chain flow models, and/or others.

Data can be collected 410 from any of a variety of data sources 310A-310C. These data sources 310A-310C can include, but are not limited to, manufacturing data sources 310A such as collected by various sensors, systems, and devices, throughout a manufacturing facility. According to one embodiment, these sources 310A can include IoT devices on equipment, parts, etc. The data sources can additionally, or alternatively, include inventory data sources 310B, supplier data sources 310C, as well as others including, but not limited to newsfeeds, weather forecasts, economic indicators, etc.

Various artificial intelligence processes can be applied 415 to the collected data and based on the models 320 to generate 420 one or more insights to the data. Such insights can include, but are not limited to, real-time forecasts of demand, changes in the supply chain, detected or predicted disruptions, detected or predicted changes in price for goods and/or services, etc.

From the generated 420 insights, one or more actions can be generated 425. These actions can include, but are not limited to, reports, notifications, or alerts. In some cases, the reports, notifications, or alerts can provide information on the insights. Additionally, or alternatively, the reports, notifications, or alters can include additional information including, but not limited to, suggestions for changes to address or take advantage of the generated insights. In yet other cases, actions can include automatic actions initiated by the ERP system to address or take advantage of the generated insights.

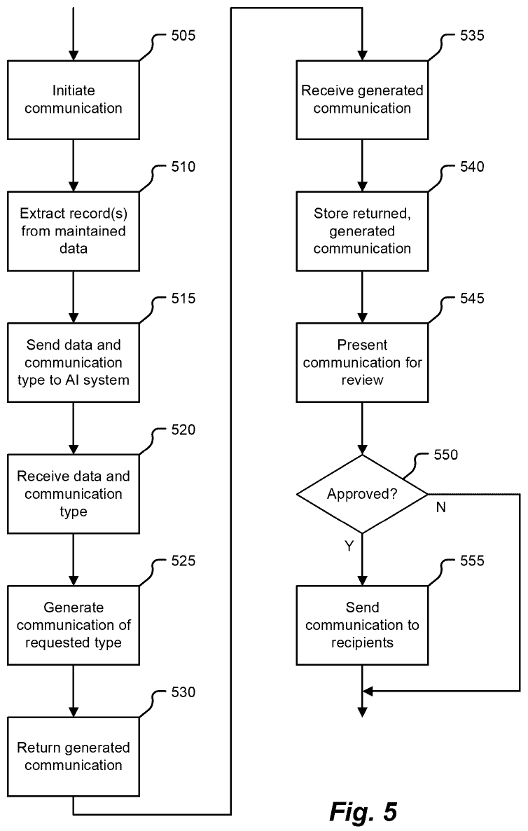

FIG. 5 is a flowchart illustrating additional details of an exemplary process for generating insights and actions according to one embodiment of the present disclosure. As noted above, applying one or more artificial intelligence processes to the collected data, generating from the one or more artificial intelligence processes, one or more insights to the data, and generating, one or more actions from the generated insights can result in automatically generating the communication can be performed in response to an initiation of an electronic communication and can result in the automatic generation of that communication. More specifically, and as illustrated in this example, applying the one or more artificial intelligence processes to the collected data can comprise initiating 505 an electronic communication within the ERP system. The electronic communication can comprise an email, messaging service message, or other electronic communication. One or more records can be extracted 510 from the maintained data and the extracted one or more records and an indication of a requested communication type can be sent 515 to an artificial intelligence system 345. In some cases, the extracted data can be encrypted before being sent 515. The artificial intelligence system 345 can receive 520 the extracted one or more records and the indication of the requested communication type from the ERP system, decrypt the received data, if necessary, generate 525 the electronic communication based on the requested communication type, the received one or more records, the one or more trained models, and a large language model, and return 530 the generated 525 electronic communication to the ERP system 305. The ERP system 305 can receive 535 and store 540 the generated electronic communication from the artificial intelligence system 345. In some cases, the received generated electronic communication can be presented 545 for approval. In response to receiving an approval 550 of the generated electronic communication, the generated electronic communication can be sent 555 to a recipient or otherwise applied in the ERP system 305.

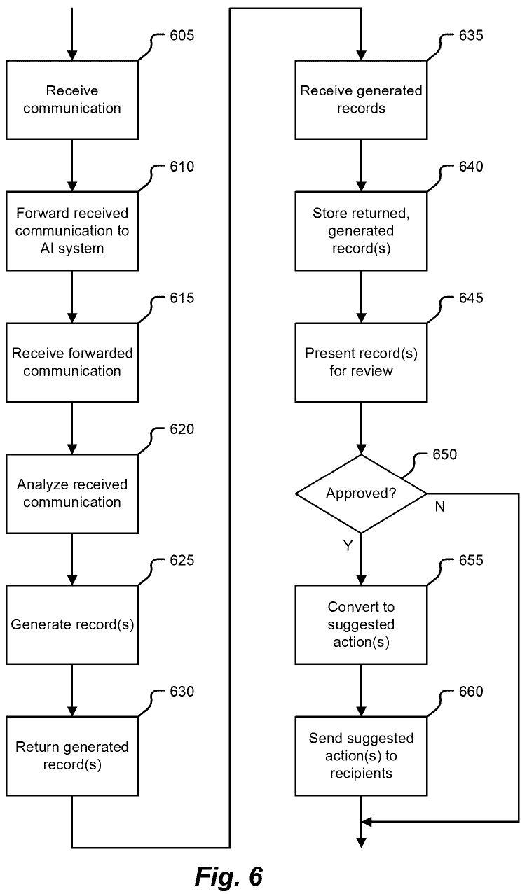

FIG. 6 is a flowchart illustrating additional details of an exemplary process for generating insights and actions according to another embodiment of the present disclosure. As noted above, applying one or more artificial intelligence processes to the collected data, generating from the one or more artificial intelligence processes, one or more insights to the data, and generating, one or more actions from the generated insights can result in automatically generating the communication can be performed in response to receiving an electronic communication. More specifically, and as illustrated in this example, applying the one or more artificial intelligence processes to the collected data can comprise receiving 605 an electronic communication and forwarding 610 the received electronic communication to the artificial intelligence system 345. The artificial intelligence system 345 can receive 615 the electronic communication forwarded by the processor of the ERP system 305, analyze 620 the received electronic communication based on the one or more trained models and a large language model, generate 625 the one or more records based on the analyzing of the received electronic communication, and return 630 the generated one or more records to the ERP system 305. The ERP system 305 can receive 635 the one or more generated records of data from the artificial intelligence system 345 and store 640 the received one or more records of data. In some cases, the received one or more records can be presented 645 for approval. In response to receiving an approval 650 of the presented on or more records, the received one or more records can be converted 655 to one or more suggested actions and the one or more suggested actions can be sent 660 to one or more recipients or otherwise applied in the ERP system 305.

The present disclosure, in various aspects, embodiments, and/or configurations, includes components, methods, processes, systems, and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for forecasting material requirements planning and inventory controls, the method comprising:
collecting, by a processor of an Enterprise Resource Planning (ERP) system, data from one or more data sources;
applying, by the processor of the ERP system, one or more artificial intelligence processes to the collected data and based on one or more trained models;
generating, by the processor of the ERP system, from the one or more artificial intelligence processes, one or more insights to the data; and
generating, by the processor of the ERP system, one or more actions from the generated insights.

2. The method of claim 1, wherein the one or more trained models comprise one or more demand models, one or more inventory level optimization models, or one or more supply chain flow models.

3. The method of claim 1, wherein the one or more data sources comprise manufacturing data sources, inventory data sources, or supplier data sources.

4. The method of claim 1, wherein the generated insights comprise one or more of real-time forecasts of demand, changes in the supply chain, detected or predicted disruptions, or detected or predicted changes in price for goods and/or services, etc.

5. The method of claim 1, wherein the generated actions comprise one or more of reports, notifications, alerts, or automatic actions initiated by the ERP system based on the generated insights.

6. The method of claim 1, wherein applying the one or more artificial intelligence processes to the collected data comprises:
initiating, by the processor of the ERP system, an electronic communication within the ERP system;
extracting, by the processor of the ERP system, one or more records from the maintained data;
sending, by the processor of the ERP system, the extracted one or more records and an indication of a requested communication type to an artificial intelligence system; and
receiving, by the processor of the ERP system, a generated electronic communication from the artificial intelligence system.

7. The method of claim 6, wherein applying the one or more artificial intelligence processes to the collected data further comprises:
presenting, by the processor of the ERP system, the received generated electronic communication for approval; and
in response to receiving an approval of the generated electronic communication, sending, by the processor of the ERP system, the generated electronic communication to a recipient.

8. The method of claim 6, wherein applying the one or more artificial intelligence processes to the collected data further comprises:
receiving, by a processor of the artificial intelligence system, the extracted one or more records and the indication of the requested communication type from the ERP system;
generating, by the processor of the artificial intelligence system, the electronic communication based on the requested communication type, the received one or more records, the one or more trained models, and a large language model; and
returning, by the processor of the artificial intelligence system, the generated electronic communication to the ERP system.

9. The method of claim 1, wherein applying the one or more artificial intelligence processes to the collected data comprises:
receiving, by the processor of the ERP system, an electronic communication;
forwarding, by the processor of the ERP system, the received electronic communication to the artificial intelligence system;
receiving, by the processor of the ERP system, one or more generated records of data from the artificial intelligence system; and
storing, by the processor of the ERP system, the received one or more records of data.

10. The method of claim 9, wherein applying the one or more artificial intelligence processes to the collected data further comprises:
presenting, by the processor of the ERP system, the received one or more records for approval; and
in response to receiving an approval of the presented on or more records, converting, by the processor of the ERP system, the received one or more records to one or more suggested actions and sending, by the processor of the ERP system, the one or more suggested actions to one or more recipients.

11. The method of claim 9, wherein applying the one or more artificial intelligence processes to the collected data further comprises:
receiving, by a processor of the artificial intelligence system, the electronic communication forwarded by the processor of the ERP system;
analyzing, by the processor of the artificial intelligence system, the received electronic communication based on the one or more trained models and a large language model;
generating, by the processor of the artificial intelligence system, the one or more records based on the analyzing of the received electronic communication; and
returning, by the processor of the artificial intelligence system, the generated one or more records to the ERP system.

12. A system comprising:
a communications network; and
an Enterprise Resource Planning (ERP) system coupled with the communications network, the ERP system comprising a processor and a memory coupled with and readable by the processor and storing therein a set of instructions which, when executed by the processor, causes the processor to:
collect data from one or more data sources;
apply one or more artificial intelligence processes to the collected data and based on one or more trained models;
generate, from the one or more artificial intelligence processes, one or more insights to the data; and
generate one or more actions from the generated insights.

13. The system of claim 12, wherein the one or more trained models comprise one or more demand models, one or more inventory level optimization models, or one or more supply chain flow models.

14. The system of claim 12, wherein the one or more data sources comprise manufacturing data sources, inventory data sources, or supplier data sources.

15. The system of claim 12, wherein the generated insights comprise one or more of real-time forecasts of demand, changes in the supply chain, detected or predicted disruptions, or detected or predicted changes in price for goods and/or services, etc.

16. The system of claim 12, wherein the generated actions comprise one or more of reports, notifications, alerts, or automatic actions initiated by the ERP system based on the generated insights.

17. The system of claim 12, wherein applying the one or more artificial intelligence processes to the collected data comprises:
initiating an electronic communication within the ERP system;
extracting one or more records from the maintained data;
sending the extracted one or more records and an indication of a requested communication type to an artificial intelligence system via the communication network; and
receiving a generated electronic communication from the artificial intelligence system via the communication network.

18. The system of claim 17, wherein applying the one or more artificial intelligence processes to the collected data further comprises:
presenting the received generated electronic communication for approval; and
in response to receiving an approval of the generated electronic communication, sending the generated electronic communication to a recipient via the communication network.

19. The system of claim 12, wherein applying the one or more artificial intelligence processes to the collected data comprises:
receiving an electronic communication via the communication network;
forwarding the received electronic communication to the artificial intelligence system via the network;
receiving one or more generated records of data from the artificial intelligence system, via the communication network; and
storing, by the processor of the ERP system, the received one or more records of data.

20. The system of claim 19, wherein applying the one or more artificial intelligence processes to the collected data further comprises:
presenting the received one or more records for approval; and
in response to receiving an approval of the presented on or more records, converting the received one or more records to one or more suggested actions and sending the one or more suggested actions to one or more recipients via the communication network.
